(19) United States
(12) Patent Application Publication
(10) Pub. No.: US 2020/0058072 A1
(43) Pub. Date: Feb. 20, 2020

(54) SYSTEM SUPPORTING THE CALCULATION OF INSURANCE RATES USING AN ANALYTICS PLATFORM

(71) Applicant: Stanford Thomas Riley, Hanceville, AL (US)

(72) Inventor: Stanford Thomas Riley, Hanceville, AL (US)

(21) Appl. No.: 16/104,110

(22) Filed: Aug. 16, 2018

(51) Int. Cl. G06Q 40/08; G06F 17/10; G06F 9/54; G06F 17/30

(52) U.S. Cl. CPC G06Q 40/08; G06F 17/30696; G06F 9/54; G06F 17/10

(57) ABSTRACT

The present invention is a method and system used for calculating insurance rates. Particularly, this invention allows the insurance rating data to be stored on an analytics platform and accessed via requests made to the analytics platform API from a web application or service, which performs calculations and returns data to a front-end application, which presents rates to the end-user.

### CROSS-REFERENCE TO RELATED APPLICATION: This application claims priority to

U.S. Provisional Patent Application No. 62/546,865, filed on Aug. 17, 2017, entitled SYSTEM SUPPORTING THE CALCULATION OF INSURANCE RATES USING AN ANALYTICS PLATFORM, the disclosure of which is incorporated herein by reference and made part of the present U.S. Utility patent application for all purposes.

### FIELD OF THE INVENTION

The present invention relates to a method and system used for calculating insurance rates as outlined in the rate filings of insurance providers. Particularly, this invention allows the insurance rating data to be stored on an analytics platform and accessed via requests made to the analytics platform's API (Application Programming Interface) from a middle-tier web application or service which performs additional calculations and returns data to a front-end application, which presents rates to the end user.

### BACKGROUND OF THE INVENTION

Actuary personnel perform statistical analysis and consider multiple factors such as gender, age, marital status, geographical location, credit score, insured product market value, and more, to determine a price for an insurance product. Management reviews, approves, and files the rates with the appropriate regulatory agency, typically the state's department of insurance. After the regulatory agency approves of the rates, the insurance provider may offer the insurance product to the consumer. As the insurance providers strive to be competitive, it is imperative to be able to respond quickly to changing market conditions.

Users of insurance rating systems are agents, customers, and prospects seeking to find a good insurance rate. These users interact with the rating systems via Internet based quoting applications using personal computers and mobile devices. Based upon the information that the user inputs, a quote is calculated and presented to the user. The front-end quoting application may offer a variety of purchase and fulfillment options to the user.

The design of many insurance rating software systems have limitations, which make it difficult to make changes in order to react to market conditions quickly. They have data structures bound to rigid models requiring substantial modifications to make any changes. These changes are also costly in terms of qualified personnel to maintain and enhance. The present invention is directed to providing the inputting of insurance rating data using a variety of data formats efficiently. In turn, the invention can reduce the number of personnel needed to make changes.

Presenting rates from multiple insurance providers is another feature that can be achieved. This process is known in the insurance industry as comparative rating. Using the same user information that is sent in a request, the system will perform the calculation of rates for the multiple programs from the insurance providers that are configured. The present invention is directed toward providing the capability of comparative rating.

Presenting real-time feedback as the user entered information changes is also another challenge. The rates could be displayed to the user as soon as a response is returned from the system. This allows for the user to perform what-if analysis as the user modifies data. An example could be, “what is the change in premium if the coverage's limit option was set to a higher level?” The present invention is directed toward providing the capability of real-time feedback as the user changes data.

Because rates change over time, there is a need to be able to rate using an effective date. This can allow rate calculations for past revisions for insurance providers. The present invention is directed toward providing the capability of quoting based on an effective date.

A drawback of some rating software systems is the lack of real-time analysis. Building a rating engine upon an analytics platform facilitates the real-time analysis via reports, dashboards, and programmable alerts. The present invention is directed toward providing real-time actionable, information allowing the management to make well-informed decisions. This invention also supports data democratization having a goal of allowing non-specialists to be able to gather and analyze data.

The verification of rates is also another problem. Insurance companies want to offer a competitive rate at a price level that that is profitable. In many cases, employees manually test various combinations of rating factors using the existing rating solution. This process is painstakingly slow and arduous. Also, this sampling verification process does not test every combination of rating factors. The present invention is directed towards providing a capability to test every possible combination of rating factors.

### SUMMARY OF THE INVENTION

The method and system of this invention center around the innovative concept of utilizing an analytics platform to store, retrieve, and analyze insurance rating data combined with a middle-tier web application acting as an orchestration service layer that performs calculations using programmable components that return information for a front-end insurance quoting application.

### BRIEF DESCRIPTION OF THE DRAWINGS

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating. Some figures contain screenshots of working examples. All product names, trademarks and registered trademarks are property of their respective owners. All company, product and service names cited herein are for identification purposes only. Accordingly:

FIG. 1 is an illustration of an example overview of key components and flow of information between the components for the embodiment of the present invention.

FIG. 2 is an illustration of a simplified calculation of a coverage premium.

FIG. 3 is an illustration of an example CSV file representing insurance data.

FIG. 4 is an example of request data that can be sent to the Quote Relay.

FIG. 5 is a logic flow diagram for the quoting system process.

FIG. 6 is a screenshot of Analytics Platform search interface displaying a search query and results for insurance rate data.

FIG. 7 is a sereenshot of JBoss Developer IDE displaying some Java source code and console output for the Quote Relay.

FIG. 8 is a screenshot of Quoting Interface driver page.

FIG. 9 is a screenshot of Quoting Interface driver page.

FIG. 10 is a screenshot of Quoting Interface vehicle page.

FIG. 11 is a screenshot of Quoting Interface coverage page.

FIG. 12 is a screenshot of Quoting Interface purchase page.

### DETAILED DESCRIPTION OF THE INVENTION

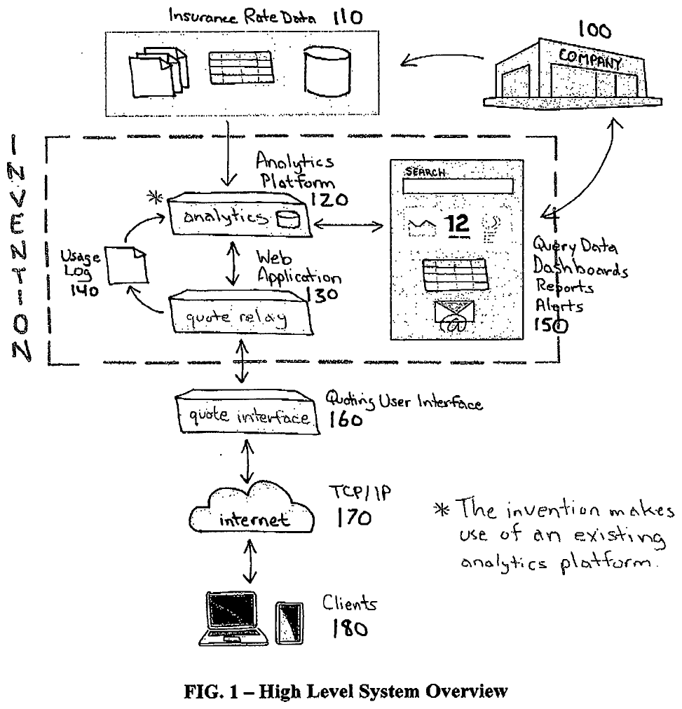

To gain an overall understanding of the method and system of the invention, it is necessary to see a simplified high-level overview of the system. FIG. 1 shows that a key component of the system invention is the analytics platform 120. The analytics platform is a pre-existing solution that has capabilities that can be exploited to deliver a custom solution. This invention utilizes an analytics platform 120 as a tool that is specifically configured to provide the functionality needed for rating insurance and to provide real-time information to management. The analytics platform 120 can do nothing by itself. It must have data imported. Dashboards, charts, reports, and alerts 150 must be created that utilize the data 110, 140 stored on the analytic platform 120. The analytics platform 120 does supply an application programmable interface (API), which can be used to retrieve information. The analytics platform 120 also provides access of data using a role-based security for the users within the company 100.

Another key component is middle-tier web application, depicted in FIG. 1 as Quote Relay 130. Quote Relay 130 is a web application that will receive requests typically in a transportable data format such as XML or SSON. The Quote Relay 130 will then make requests to the analytics platform 120 using its API. After a response is received from the analytics platform 120, the component objects in Quote Relay 130 will perform calculations utilizing the data that was returned. A response containing the calculated insurance premium will be returned to the Quoting Interface 160.

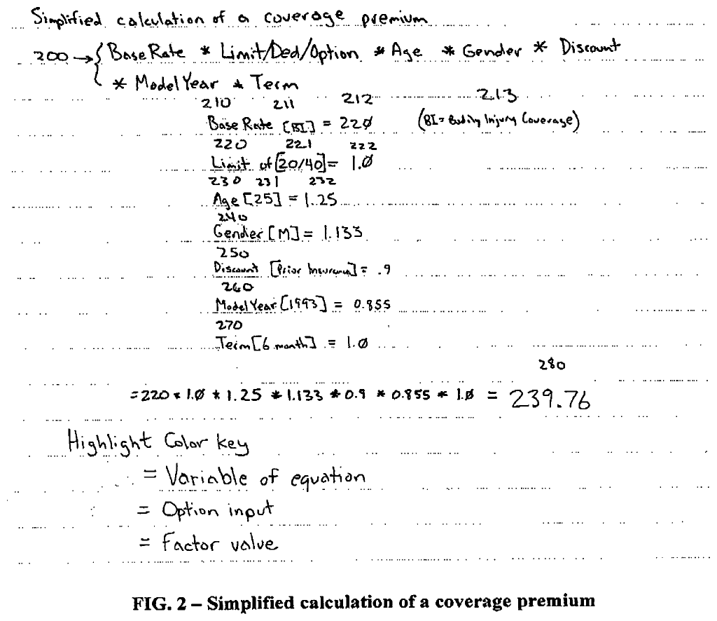

It is also necessary to understand that insurance premiums are calculated depending on the coverage limits, deductibles, and options in addition to the other factors such as driving record, age, gender, marital status, and the make and model of the vehicle just to name a few. Equations for the calculation of premium are developed by the company and filed with the state regulatory agency in which they will conduct the business. FIG. 2. Illustrates a simplified equation for the calculation of a coverage premium 200. The simplified equation has seven factors, which are as follows: Base Rate 210, Limit 220, Age 230, Gender 240, Discount 250, Model Year 260, and Term 270. The numeric value of each of these factors is dependent upon some input data. For the Base Rate factor 210, the input data is “BI” 211 (Bodily Injury) and the factor's value is “220” 212. For the Limit factor 220, the input data is “20/40” 221 and the factor's value is “1.0” 222. For the Age factor 230, the input data is “25” 231 and the factor's value is “1.25” 232 and so on. After all of the factor's values has been retrieved, the equation can be calculated. As shown in FIG. 2, the Bodily Injury coverage premium is calculated to be “$239.76” 280. The quote(s) may contain the calculated premiums for multiple coverages for multiple programs for multiple companies.

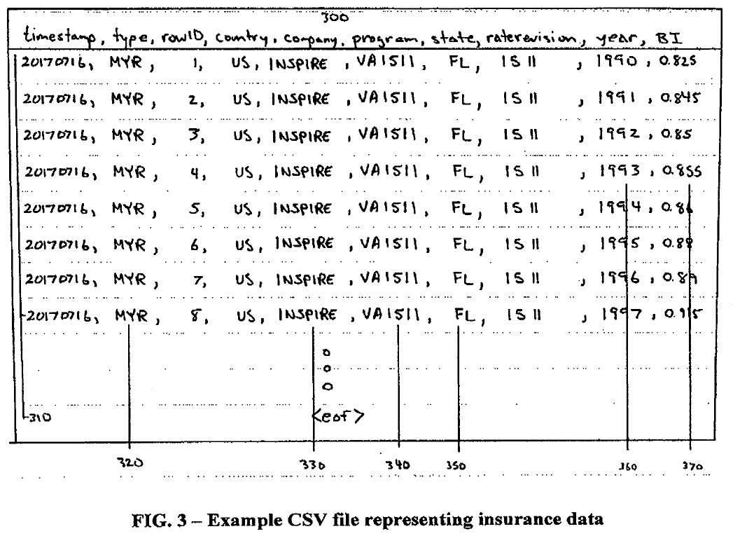

The first step needed of the method and system of the invention is to import the rating data into the analytics platform. The analytics platform has many choices of data formats for importing but for the purposes of explaining the invention, the data is input using the CSV (comma separated value) format as shown in FIG. 3. The analytics platform will index the data using the first line of the data file as heading data and creates variable names 300. The succeeding lines represent the data values that are used for the calculation of the insurance rate 310. The import functionality is a feature of the analytics platform.

To obtain a rating factor's specific value based on input criteria, lets examine the model year factor. Model year is a number that approximates the calendar year that a vehicle was built. Referring to FIG. 3, the type values are “MYR” 320 an abbreviation for model year. The data for model year “1993” 360 for the company of “INSPIRE” 330 and the program of “VA1511” 340 (Value Added—November 2015) for the state of “FL” 350 (Florida) for the coverage of “BI” 370 (Bodily Injury) is 0.855, The analytics platform supports the querying of data using the headings as variable names. A formulated query that is used by the analytics platform to retrieve the value for this specific criteria would be similar to the following: country=“US” company=“INSPIRE” state=“FL” program=“VA1511” type=“MYR” year=“1993”|table BI.

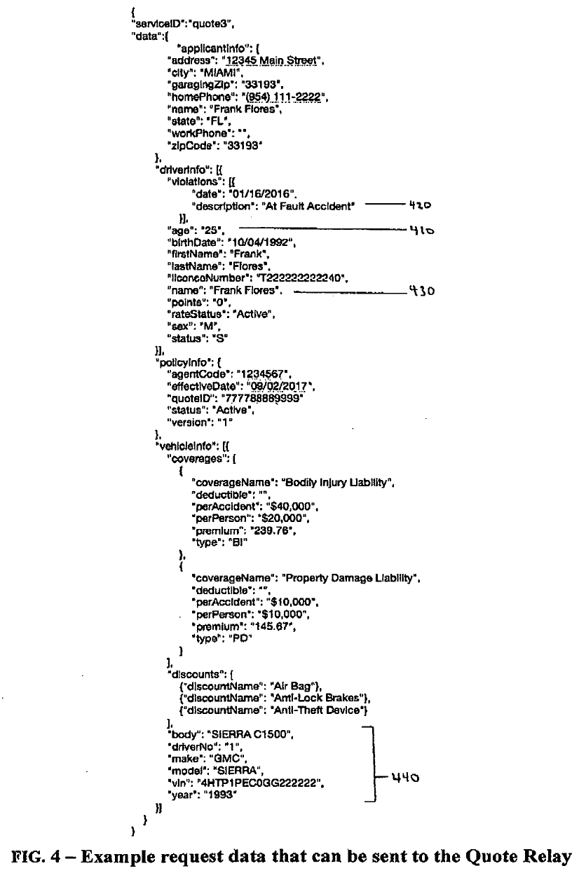

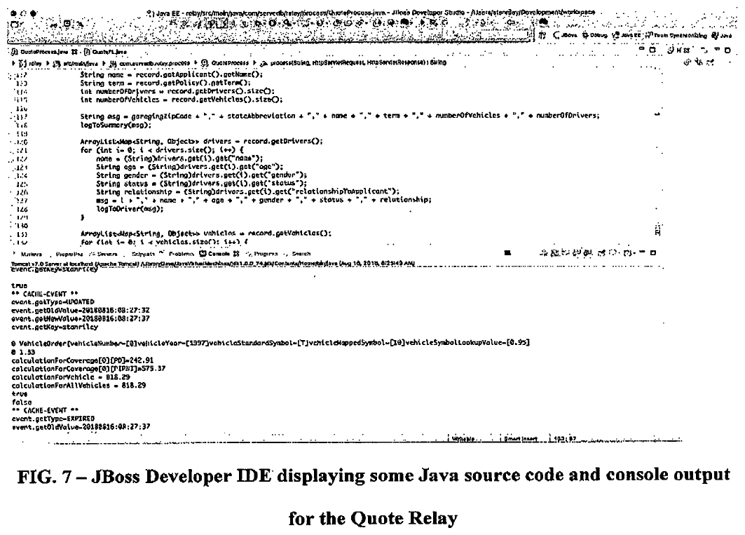

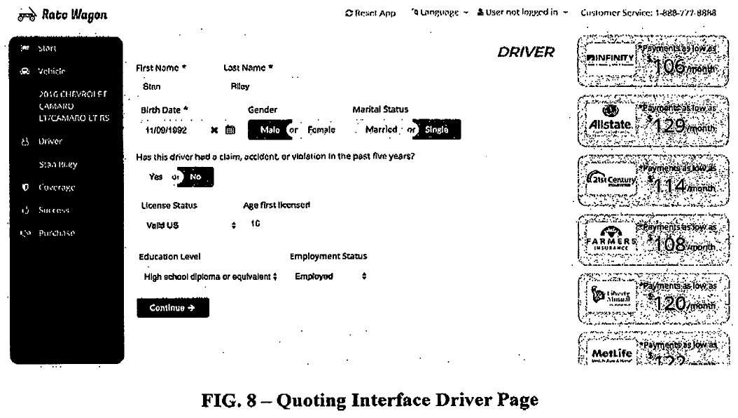

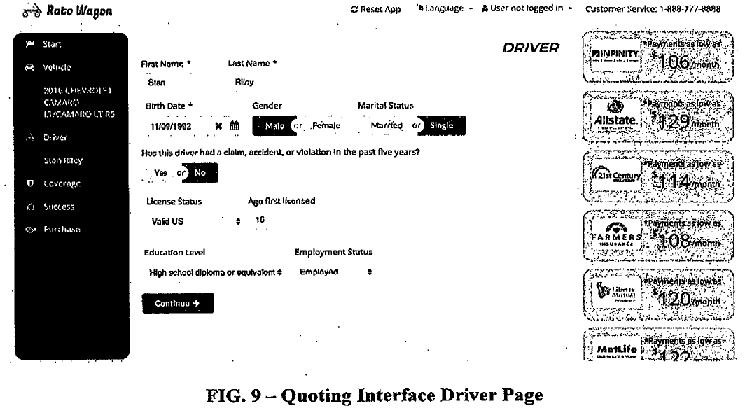

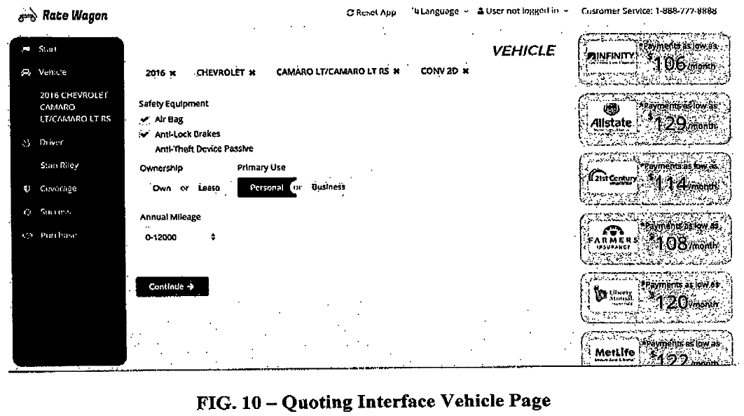

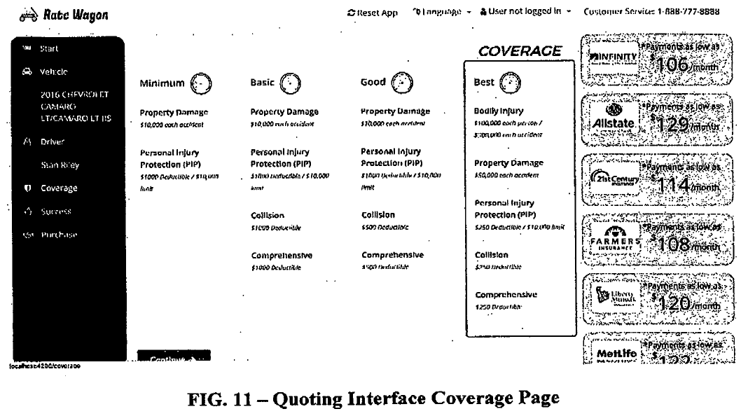

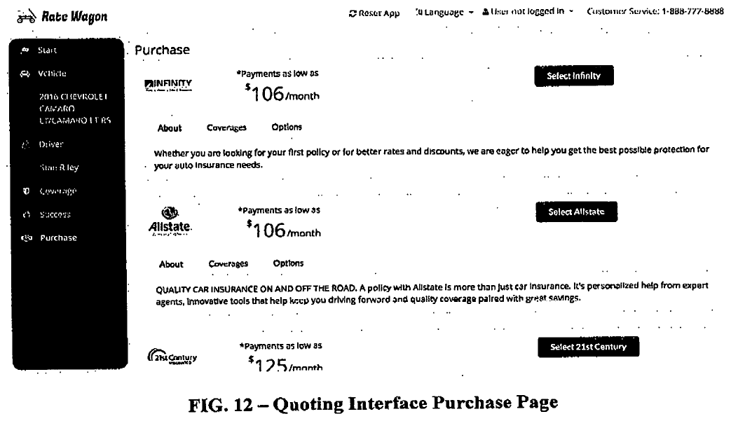

The Quote Relay is the middle-tier web application that receives a request from the client, validates the input request, performs the action for the specific input, and returns a response to the client. FIG. 7 contains a screenshot of the IDE, Integrated Development Environment, running the Quote Relay 130. The client is typically a Quoting Interface, which a user interacts with. The Quoting Interface will send request data the Quote Relay in a transportable format such as XML (eXtensible Markup Language) or JSON (JavaScript Object Notation) and contains the necessary information to be used as input for the calculation of insurance rates. An example of request data to the Quote Relay is shown in FIG. 4. Examples of pages in a Quoting Interface are shown in FIG. 8-12.

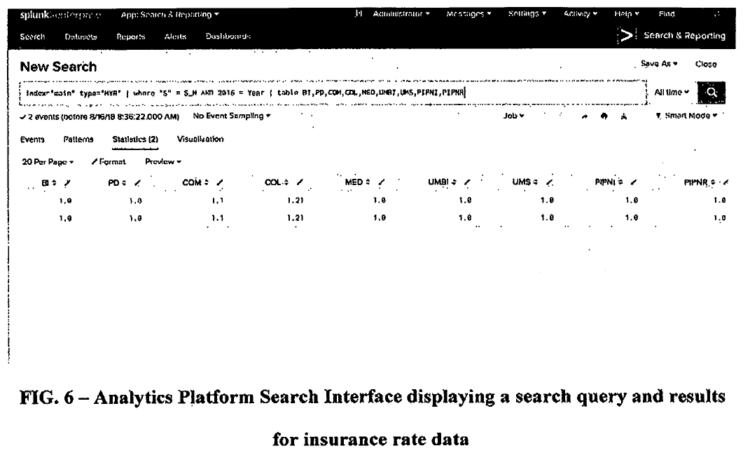

Referring to FIG. 4, it is easy to obtain information such as the driver's age by parsing the JSON data structure. The data reveals the following information: the driver's age is “25” 410; the driver had an at-fault accident on “1/16/2016” 420; the driver's name is “Frank Flores” 430; and that the driver's vehicle is a “1993 GMC Sierra” 440. These data items are used as input options for the queries that are submitted to the Analytics Platform to retrieve the values for the factors to calculate the insurance premium. Once again, the formulated query that is used by the analytics platform to retrieve the value for this specific criteria would be similar to the following: country=“US” company=“INSPIRE” state=“FL” program=“VA1511” type=“MYR” year=“1993”|table BI. FIG. 6. contains a screenshot of an Analytics Platform interface containing a search query and results.

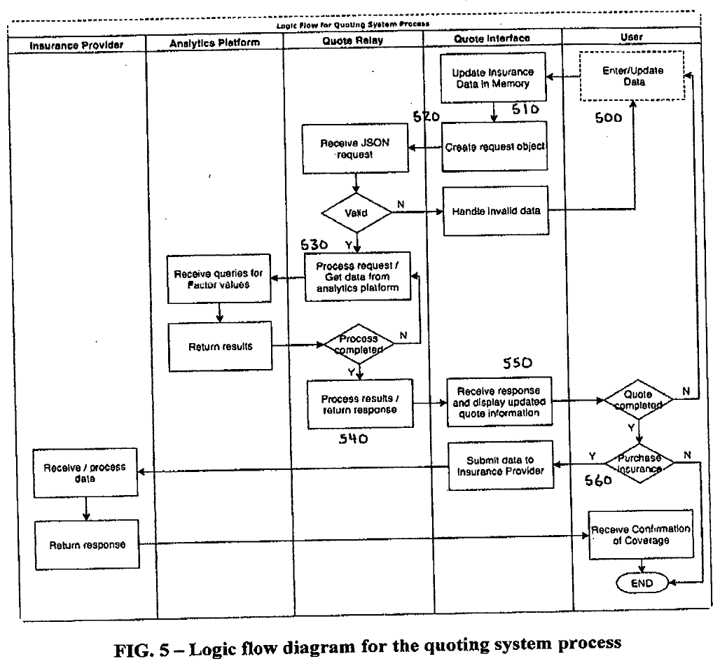

For further understanding of the interactions occurring in the system of the invention a Logic Flow Diagram for a Quoting System process is shown in FIG. 5. A user enters data at the start of the quoting system process 500. The data is updated in the Quoting Interface 510. A request is then sent to the Quote Relay 520. The Quote Relay processes the request and makes requests to the Analytics Platform 530. Once the values are retrieved, the Quote Relay calculates the insurance rates and delivers results to the Quoting Interface 540. The Quoting Interface presents the results to the user 550. The user then can choose to purchase insurance once the quoting process has been completed 560.

The method and system of invention is directed towards the process of the looking up the factor values for the criteria, performing the logic surrounding the steps of the each calculation, and returning the calculated values for the input request data. This is the primary responsibility of the Quote Relay, which makes full use of the capabilities of the Analytics Platform to obtain values for the calculations.

The method and system of invention is not limited to calculation of rates for automobile insurance. The present invention can be used to perform calculations for rates of homeowner's, life, or other insurance.

1. The analytics platform as a component of a rating system provides a capability to compute insurance rates.
(a) Rates can be calculated by retrieving the data from the analytics platform and performing calculations on the data using the specifications of an insurance companies rating policy and guidelines which is programmed into an application or service.

2. The analytics platform as a component of a rating system creates an efficiency for data loading and access.
(a) Data can be input in a variety of formats (i.e. text, csv, json, xml).
(b) Data does not have to be structured.
(c) Data can be retrieved by executing queries using the platform's API.

3. The analytics platform as a component of a rating system allows real-time analysis on the rating system.
(a) Reports, dashboards, and alerts can provide operational insight.
(b) Actionable information can be reported. For example, if a particular vehicle submitted in the request is not found, an error can be reported which allows the maintainer to make corrections.
